(19) United States
(12) Patent Application Publication
(10) Pub. No.: US 2024/0144149 A1
(43) Pub. Date: May 2, 2024

(54) COMPLETION LEVEL PHYSICAL ACTIVITY VALIDATION

(71) Applicant: INTERNATIONAL BUSINESS MACHINES CORPORATION, ARMONK, NY (US)

(72) Inventors: Atul Mene, Morrisville, NC (US); Tushar Agrawal, West Fargo, ND (US); Sarbajit K. Rakshit, Kolkata (IN); Jeremy R. Fox, Georgetown, TX (US)

(21) Appl. No.: 18/050,107

(22) Filed: Oct. 27, 2022

(51) Int. Cl. G06Q 10/06; G06N 5/02

(52) U.S. Cl. CPC G06Q 10/06395; G06N 5/022

(57) ABSTRACT

According to one embodiment, a method, computer system, and computer program product for activity progress validation is provided. The embodiment may include capturing user movements through one or more IoT devices. The embodiment may also include identifying an activity associated with the captured user movements. The embodiment may further include identifying performance requirements related to the identified activity. The embodiment may also include calculating a quality level metric and a progress-toward-completion metric of the activity based on the performance requirements. The embodiment may further include displaying each metric on a graphical user interface associated with a user device.

### BACKGROUND

The present invention relates generally to the field of computing, and more particularly to the Internet of Things (IoT).

IoT relates to an interrelated system of objects that are capable of transferring data across a network without requiring human participation. Currently, many devices available in the consumer marketplace are equipped with “smart” capabilities which include the capability to connect to a network through wired or wireless connections. These devices include many items from smartphones and wearables to refrigerators, lightbulbs, and vehicles. Despite many known uses in the commercial sphere, IoT can also be utilized industrially to improve efficiency and reduce consumable resources. For example, implementing IoT technology throughout a city transportation or electrical grid may assist in reduction of traffic or inefficient energy usage.

### SUMMARY

According to one embodiment, a method, computer system, and computer program product for activity progress validation is provided. The embodiment may include capturing user movements through one or more IoT devices. The embodiment may also include identifying an activity associated with the captured user movements. The embodiment may further include identifying performance requirements related to the identified activity. The embodiment may also include calculating a quality level metric and a progress-toward-completion metric of the activity based on the performance requirements. The embodiment may further include displaying each metric on a graphical user interface associated with a user device.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for an activity progress validation process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to the Internet of Things (IoT). The following described exemplary embodiments provide a system, method, and program product to, among other things, assess user progress toward task completion using IoT devices. Therefore, the present embodiment has the capacity to improve the technical field of IoT by leveraging existing data feeds from IoT devices to calculate and present quantitative metrics for completion progress for a current user task, thereby improving system uptime.

As previously described, IoT relates to an interrelated system of objects that are capable of transferring data across a network without requiring human participation. Currently, many devices available in the consumer marketplace are equipped with “smart” capabilities which include the capability to connect to a network through wired or wireless connections. These devices include many items from smartphones and wearables to refrigerators, lightbulbs, and vehicles. Despite many known uses in the commercial sphere, IoT can also be utilized industrially to improve efficiency and reduce consumable resources. For example, implementing IoT technology throughout a city transportation or electrical grid may assist in reduction of traffic or inefficient energy usage.

On an industrial floor, human workers may perform various different tasks from process line work to machine repair. Any task being performed with bare hands or tools may require the application of physical force at various angles, levels, and hand movements. Furthermore, different tools possess different specifications, such as length and gripping method. For an individual to complete a task (e.g., machine repair) any number of subtasks, or activities, may need to be completed, such as tightening a screw, using a lever to lift an object, gripping pattern of an object, etc. If the individual does not perform an activity correctly (e.g., not enough force or applying force at an incorrect angle), the individual may not be able to properly complete the activity or may complete the activity more slowly or inefficiently than if the activity were performed correctly. Furthermore, incorrect completion of an activity may result in injury to the user of damage to the subject item of the activity. As such, it may be advantageous to, among other things, utilize IoT devices to identify an activity and present to the user whether the activity is being performed correctly and progress-toward-completion metrics of the activity.

According to one embodiment, an activity progress validation program may capture user motions and body positions while the user is completing a task through IoT device, such as cameras and wearables, feeds. Through an analysis of the motions and body positions, the activity progress validation program may determine whether the user is completing subtasks, or activities, associated with task with satisfactory quality. Furthermore, the activity progress validation program may make an assessment as to the progress towards completion of each activity and the task as a whole then present that determination to the user on a graphical user interface associated with a wearable device, such as a smart watch.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

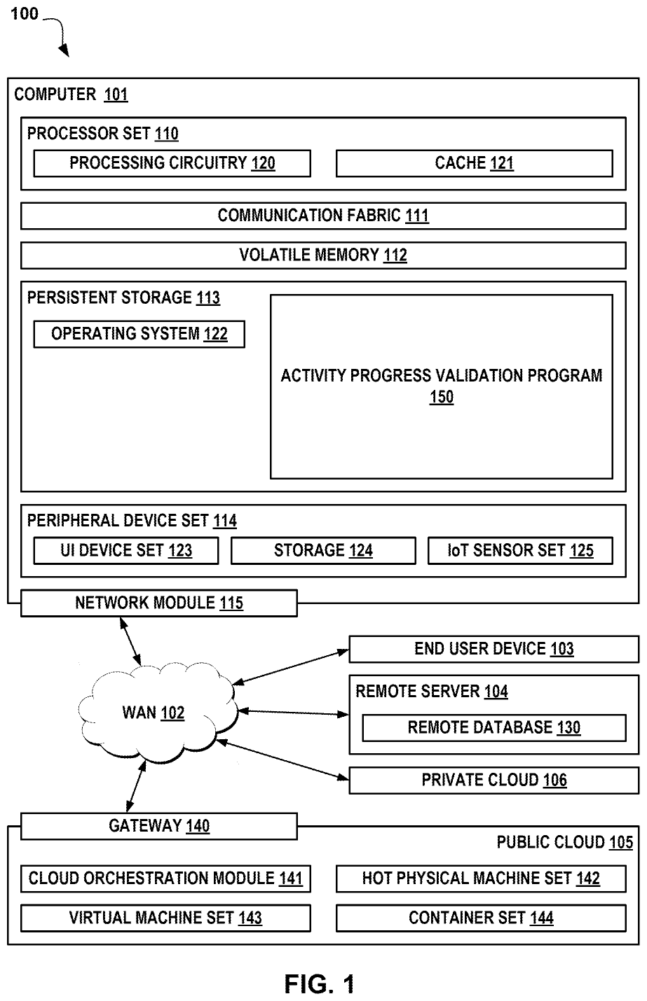

Referring now to FIG. 1, computing environment 100 contains an example of an environment for the execution of at least some of the computer code involved in performing the inventive methods, such as activity progress validation program 150. In addition to activity progress validation program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and activity progress validation program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in activity progress validation program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in activity progress validation program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

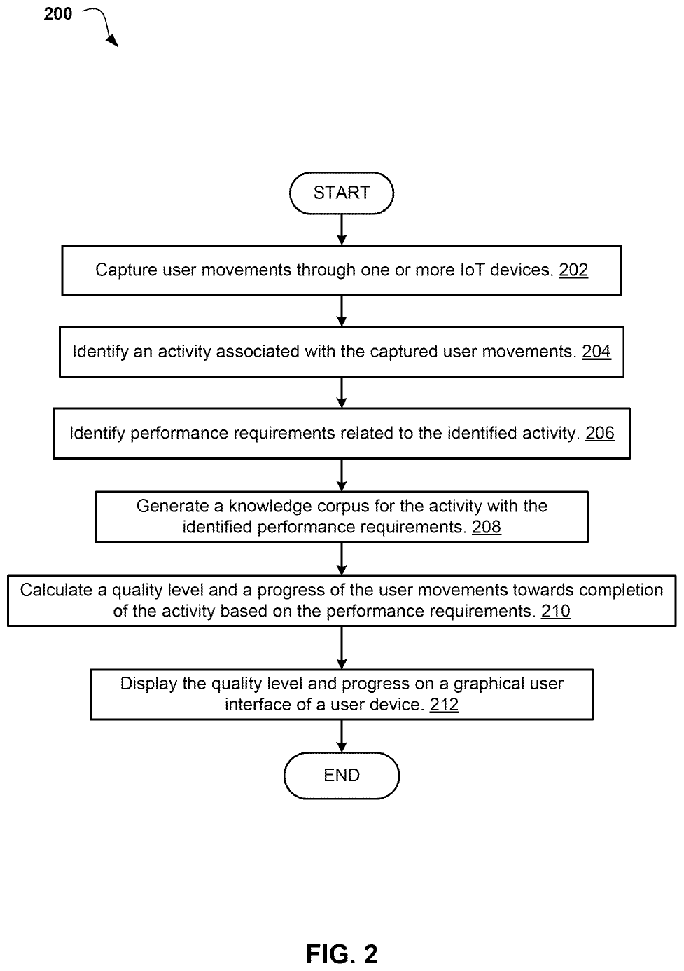

According to at least one embodiment, the activity progress validation program 150 may capture information available IoT device feeds, such as feeds from IoT sensor set 125. Using the feed information, the activity progress validation program 150 may identify the specific task, environmental parameters, and, through analysis of an available knowledge corpus, any subtasks, or activities, associated with the task that need to be performed for task completion. The activity progress validation program 150 may continue to use the captured IoT feed information to determine various metrics relating to the activities being performed by the user, such as, but not limited to, direction of applied force, magnitude of applied force, and type of tool being utilized. Furthermore, the activity progress validation program 150 may determine, through the knowledge corpus, the quality of the user actions required to perform each activity under the specific parameters identified through the IoT device feed. The activity progress validation program 150 may then calculate a metric relating to the progress of the user actions toward completion of each activity and present the calculated progress metric to the user on a graphic user interface (e.g., a smart watch display screen). Furthermore, notwithstanding depiction in computer 101, the activity progress validation program 150 may be stored in and/or executed by, individually or in any combination, end user device 103, remote server 104, public cloud 105, and private cloud 106. The activity progress validation method is explained in more detail below with respect to FIG. 2.

Referring now to FIG. 2, an operational flowchart for an activity progress validation process 200 is depicted according to at least one embodiment. At 202, the activity progress validation program 150 captures user movements through one or more IoT devices. The one or more IoT devices may be any device discussed with respect to IoT sensor set 125 including, but not limited to, one or more distributed video or image capture devices and one or more wearable devices. Each IoT device may include or more sensors including, but not limited to, proximity sensors, accelerometers, infrared sensors, pressure sensors, light sensors, ultrasonic sensors, touch sensors, color sensors, humidity sensors, position sensors, magnetic sensors (e.g., Hall effect sensor), sound sensors (e.g., microphones), tilt sensors (e.g., gyroscopes), flow sensors, level sensors, strain sensors, and weight sensors. For example, the activity progress validation program 150 may obtain a video of a user performing an activity on an industrial floor with a specific tool (e.g., a spanner) while the user is also wearing a smart watch that captures the user's heartrate, perspiration level, wrist angle, and force applied on a tool. Additionally, the activity progress validation program 150 may calculate various metrics related to the captured user movements using the one or more IoT devices. For example, the activity progress validation program 150 may measure the magnitude of stress exerted by a flexed muscle when performing a specific movement, the direction or rotation of the applied force of the flexed muscle, and the time duration of the applied force.

In at least one embodiment, the activity progress validation program 150 may require the user to opt into the capture and analysis of user movements and sensor data utilized by the activity progress validation program 150. The opt in procedure may be a confirmation or any other user interaction with a user device or a display screen associated with a user device.

Then, at 204, the activity progress validation program 150 identifies an activity associated with the captured user movements. The activity progress validation program 150 may analyze the data received from the IoT device feed(s) to identify the activity with which the user is engaging. For example, the activity progress validation program 150 may analyze user movements captured by a video capture device with image recognition technology to determine that the user's hand is twisting a tool in a manner consistent with the tightening of a screw with a screwdriver. Additionally, the activity progress validation program 150 may utilize active sensors, such as a proximity sensor, from a wearable device, such as a smart watch, to determine the activity being engaged in. Furthermore, the activity progress validation program 150 may utilize the current user location, as identified through one or more location detection technologies, such as a global positioning system or cellular triangulation, to determine the user's location while performing the activity. For example, if a GPS-determined location indicates the user is performing the activity on a shingled roof of a residential building while raising and lowering their arm while also clasping a tool, the activity progress validation program 150 may identify the activity being performed as securing new shingles to the residential building using a hammer and nails along with specific metrics of the tools used, such as hammer size and type and nail length, and forces applied, such as magnitude of force hitting the nail head with each swing of the hammer.

In at least one embodiment, the activity progress validation program 150 may utilize a historical corpus of activities and any associated user movements and entities used in conjunction with the user movements to identify the current user movement. For example, if a smart watch proximity sensor, accelerometer, and gyroscope indicate that the user is twisting their hand clockwise while clasping a tool, the activity progress validation program 150 may identify the activity being performed, as indicated by a historical corpus of user movements, is tightening a screw.

Furthermore, the activity progress validation program 150 may utilize the machine or tool, if smart-enabled, to identify the activity. For example, the activity progress validation program 150 may connect through a network, such as WAN 102, with a smart-enabled wrench to determine that the activity being performed by the user is the loosening of a nut from a bolt.

In at least one embodiment, the activity progress validation program 150 may identify various parameters and environmental conditions regarding the identified activity. For example, continuing the above-mentioned scenario regarding the user implementing a wrench to loosen a nut from a bolt, the activity progress validation program 150 may determine that the nut is rusted to the bolt and the degree with which the rust is present. Conversely, the activity progress validation program 150 may identify the presence of lubricant on a nut that may indicate a lesser application of force is required to loosen the nut from the bolt.

Next, at 206, the activity progress validation program 150 identifies performance requirements related to the identified activity. The activity progress validation program 150 may utilize certain requirements necessary for completing the identified activity using one or more available databases, such as storage 124 or remote database 130. For example, the activity progress validation program 150 may identify the amount of torque required to loosen a tightened nut from a threaded bolt through a manufacturer's database. Additionally, the activity progress validation program 150 may identify the proper procedure for performing the activity most efficiently. For example, the activity progress validation program 150 may identify, through an available database, the specific arm and hand angles needed to complete the activity of loosening a nut from a threaded bolt with the identified force. In at least one embodiment, the activity progress validation program 150 may identify the performance requirements from a knowledge corpus of previously performed activities and performance requirements identified for those activities stored in storage 124 or remote database 130.

Then, at 208, the activity progress validation program 150 generates a knowledge corpus for the activity with the identified performance requirements. If a knowledge corpus of performance requirements for the identified activity does not exist or is not available, the activity progress validation program 150 may generate a knowledge corpus for the identified activity and store all future identified activities within the same knowledge corpus. In at least one embodiment, a repository, such as storage 124 or remote database 130, may store the knowledge corpus.

The knowledge corpus may contain various metrics related to an activity and completion of the activity. For example, the knowledge corpus may contain manufacturer specifications for the amount of torque required for unbolting or tightening an item, force required for movement of an item, and direction of applied force for movement.

Next, at 210, the activity progress validation program 150 calculates a quality level and a progress of the user movements towards completion of the activity based on the performance requirements. Upon identifying the activity and determining the various metrics related to the activity, the activity progress validation program 150 may determine the quality of the user's current movements while performing the activity and the progress of those movements towards completion of the activity. The activity progress validation program 150 may determine the quality of the user movements through an analysis (e.g., a comparison) of the captured user movements through the one or more IoT devices against the identified performance requirements. For example, if a bolt requires a specific level of torque with the most efficient angle of the user's arm and wrist at a specific angle, the activity progress validation program 150 may analyze the captured user movements, as described in step 202, to determine if the user is applying the appropriate amount of torque while maintaining an efficient arm and wrist angle. In at least one embodiment, the activity progress validation program 150 may also assess the quality of the user movements toward completing the activity as any preconfigured information, such as, but not limited to, a preconfigured way to perform the activity (e.g., specific, preferred user movements to complete the activity in a most efficient manner), completing the activity within a preconfigured time, and completing the activity without causing damage to any entity (e.g., machine, tool, or individual) involved in the activity.

The activity progress validation program 150 may also calculate the progress toward completion of the activity based on the current user movements. Using the quality level and the performance requirements to complete the activity, the activity progress validation program 150 may calculate a value representative of the progress toward completion of the activity. For example, if a specific amount of torque is required for a wrench to loosen a nut from a bolt and the user is applying 85% of the specific amount of torque, then the activity progress validation program 150 may determine the value representative of the progress toward completion is 85%.

In at least one embodiment, the activity progress validation program 150 may also calculate a time and effort savings should the user correct the user movements to be in conformance with the identified performance requirements. For example, if the activity progress validation program 150 determines the user is using only their fingers to twist a screwdriver, which is determined to be less efficient than using wrist and/or forearm muscles to perform the same twist of the screwdriver, the activity progress validation program 150 may calculate the time and energy savings should the user utilize their wrist and/or forearm muscles to complete the activity of securing a screw with a screwdriver.

Then, at 212, the activity progress validation program 150 displays the quality level and progress on a graphical user interface of a use device. The activity progress validation program 150 may utilize any display screen available to the user to display the calculated quality level and progress towards completion to the user. For example, the activity progress validation program 150 may display the quality level and progress toward completion to the user as numerical values on the display screen of a smart watch worn on the user's wrist or on a nearby laptop. Similarly, the activity progress validation program 150 may display a color-coded icon representative of the quality and/or the progress toward completion. For example, if the user is using force well below the recommended force to hammer in a nail, the activity progress validation program 150 may display a red color-coded icon on the display screen. Additionally, the activity progress validation program 150 may utilize a graph to indicate progress towards completion of the activity. For example, the activity progress validation program 150 may display a bar graph with a number of ticks along the bar graph (e.g., 100 ticks). When the activity progress validation program 150 determines the user has completed 1% of the activity, the activity progress validation program 150 may change the color of the left-most box, or bottom-most box depending on the orientation of the graph, that is displayed in the original color. In such a scenario, the activity progress validation program 150 may display activity completion when all ticks along the bar graph have been filled in or changed color. Furthermore, the activity progress validation program 150 may instruct the user device to play a sound when the activity has completed. For example, if the activity is the tightening of a nut onto a bolt with a wrench, the activity progress validation program 150 may play a preconfigured sound (e.g., a ding) when the user has tightened the nut to the manufacturer's recommended specifications as determined from the knowledge corpus.

It may be appreciated that FIG. 2 provides only an illustration of one implementation and does not imply any limitations with regard to how different embodiments may be implemented. Many modifications to the depicted environments may be made based on design and implementation requirements. For example, the activity progress validation program 150 may be scaled to utilize the movements of many users when generating and updating the knowledge corpus based on a defined group, set of users, squad, team, or any other defined collection of individual profiles, such as an athletic trainer monitoring the movements of athletes or a foreman monitoring worker movements while performing activities on a construction site.

In at least one other embodiment, the activity progress validation program 150 may alert the user performing the activity that the capture user movements fall outside of a preconfigured threshold of safe operation. For example, if the user is performing the activity of lifting a heavy item and the captured user movements indicate that the user is using their back muscles more than recommended, the activity progress validation program 150 may alert the user (e.g., through a notification on a smart watch) that the user is performing the activity in an unsafe and/or unrecommended manner and provide recommended corrections (e.g., lift with leg muscles instead of back muscles to avoid injury).

In another embodiment, the activity progress validation program 150 may extend to other users' wearable devices based on a captured video feed within a different knowledge corpus. For example, a user that is visiting an area may affect, or be affected by, a knowledge corpus that is owned or managed from another user's location. Such may be the case when a subcontractor visits a work site to perform a specific task. In such situations, the activity progress validation program 150 may require the visiting user to opt in to sharing data with the activity progress validation program 150 in order to take advantage of available features.

In yet another embodiment, the activity progress validation program 150 may update data within the knowledge corpus when entities previously associated with activities in the knowledge corpus change. For example, if a user replaces a tool and the replacing tool differs in specifications from the replaced tool, the activity progress validation program 150 may update the knowledge corpus to reflect the update specifications of the replacing tool. As a more detailed example, the user may need to replace a 16″ hammer that was used in several activities and has usage data retained within the knowledge corpus. If the user replaces the 16″ hammer with a 14″ hammer that is slightly heavier, the activity progress validation program 150 may update activities within the knowledge corpus to accurately reflect any changes necessary to calculated completion and quality metrics for specific activities (e.g., amount of force required to drive a nail, height of swing, etc.).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
capturing user movements through one or more IoT devices;
identifying an activity associated with the captured user movements;
identifying performance requirements related to the identified activity;
calculating a quality level metric and a progress-toward-completion metric of the activity based on the performance requirements; and
displaying each metric on a graphical user interface associated with a user device.

2. The method of claim 1, further comprising:
generating a knowledge corpus for the activity with the identified performance requirements.

3. The method of claim 2, wherein identifying the activity utilizes the knowledge corpus, and wherein the knowledge corpus is a historical corpus of activities, activity completion metrics, user movements, and entities used in conjunction with the user movements associated with each activity.

4. The method of claim 1, where the performance requirements are parameters necessary for completion of the identified activity.

5. The method of claim 1, wherein the quality level metric is a quantitative, differential comparison between the captured user movements and the identified performance requirements.

6. The method of claim 1, wherein the progress-towards-completion metric is a quantitative percentage value of progress of the user movements to completing the activity.

7. The method of claim 3, further comprising:
calculating a time savings metric and an effort savings metric, wherein the time savings metric is a differential value of time to complete the activity according to the knowledge corpus and time to complete the activity as determined by the captured user movements, and wherein the effort savings metric is a differential value of energy to complete the activity according to the knowledge corpus and energy to complete the activity as determined by the captured user movements.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
capturing user movements through one or more IoT devices;
identifying an activity associated with the captured user movements;
identifying performance requirements related to the identified activity;
calculating a quality level metric and a progress-toward-completion metric of the activity based on the performance requirements; and
displaying each metric on a graphical user interface associated with a user device.

9. The computer system of claim 8, further comprising:
generating a knowledge corpus for the activity with the identified performance requirements.

10. The computer system of claim 9, wherein identifying the activity utilizes the knowledge corpus, and wherein the knowledge corpus is a historical corpus of activities, activity completion metrics, user movements, and entities used in conjunction with the user movements associated with each activity.

11. The computer system of claim 8, where the performance requirements are parameters necessary for completion of the identified activity.

12. The computer system of claim 8, wherein the quality level metric is a quantitative, differential comparison between the captured user movements and the identified performance requirements.

13. The computer system of claim 8, wherein the progress-towards-completion metric is a quantitative percentage value of progress of the user movements to completing the activity.

14. The computer system of claim 10, further comprising:
calculating a time savings metric and an effort savings metric, wherein the time savings metric is a differential value of time to complete the activity according to the knowledge corpus and time to complete the activity as determined by the captured user movements, and wherein the effort savings metric is a differential value of energy to complete the activity according to the knowledge corpus and energy to complete the activity as determined by the captured user movements.

15. A computer program product, the computer program product comprising:
one or more computer-readable tangible storage medium and program instructions stored on at least one of the one or more tangible storage medium, the program instructions executable by a processor capable of performing a method, the method comprising:
capturing user movements through one or more IoT devices;
identifying an activity associated with the captured user movements;
identifying performance requirements related to the identified activity;
calculating a quality level metric and a progress-toward-completion metric of the activity based on the performance requirements; and
displaying each metric on a graphical user interface associated with a user device.

16. The computer program product of claim 15, further comprising:
generating a knowledge corpus for the activity with the identified performance requirements.

17. The computer program product of claim 16, wherein identifying the activity utilizes the knowledge corpus, and wherein the knowledge corpus is a historical corpus of activities, activity completion metrics, user movements, and entities used in conjunction with the user movements associated with each activity.

18. The computer program product of claim 15, where the performance requirements are parameters necessary for completion of the identified activity.

19. The computer program product of claim 15, wherein the quality level metric is a quantitative, differential comparison between the captured user movements and the identified performance requirements.

20. The computer program product of claim 15, wherein the progress-towards-completion metric is a quantitative percentage value of progress of the user movements to completing the activity.
